(19) United States
(12) Patent Application Publication
(10) Pub. No.: US 2010/0220949 A1
(43) Pub. Date: Sep. 2, 2010

(54) BEARING ARRANGEMENT

(75) Inventors: Richard Baier, Aurachtal (DE); Andreas Heinz, Nuernberg (DE); Norbert Radinger, Nuernberg (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/664,271

(22) PCT Filed: May 6, 2008
(86) PCT No.: PCT/EP2008/055540

§ 371 Date: Feb. 9, 2010

(30) Foreign Application Priority Data
Jun. 13, 2007 (DE) 10 2007 027 161.3

(51) Int. Cl. F16C 35/04; B23P 17/00

(52) U.S. Cl. 384/511; 29/898.065

(57) ABSTRACT

The invention relates to a bearing arrangement (1) comprising an at least partially planar bearing support (2) that has a supporting bore (5), and at least one bearing (6) which is connected to said bearing support (2). An external ring (7) of the bearing (6) is provided with a recess (14) for accommodating the bearing support (2). According to the invention, the axially internal end of the recess (14) has an undercut (15), the diameter (D1) of which in relation to a bearing axis (11) is smaller than a diameter (D2) formed by an axially extending section of the recess (14). A slotted ring-type holding element (16) which positively covers the bearing support (2) in a radial direction in at least one circumferential point is inserted into the undercut (15).

### FIELD OF THE INVENTION

The invention relates to a bearing arrangement, composed of a bearing carrier which is of at least partially planar design and has a holding bore, and of at least one bearing which is connected to said bearing carrier, with an outer ring of the bearing having a recess for holding the bearing carrier. The invention also relates to methods for producing the bearing arrangement.

### BACKGROUND OF THE INVENTION

Bearing arrangements of said type, in which a rolling bearing is held by a bearing carrier, are often required for fixing bearings in the field of gearbox construction.

For example, DE 200 19 278 U1 discloses a connection between a bearing carrier and a bearing in which the bearing outer ring is provided with a recess which slopes down inward in the axial direction. A bearing carrier is snapped into said recess, the holding bore of which bearing carrier has retaining lugs spaced apart uniformly around the circumference. As the bearing carrier is pushed axially into the recess of the bearing ring, the retaining lugs are supposed to deflect elastically and, after the lowest part of the recess is reached, assume their initial position such that the bearing carrier and the associated bearing form a non-detachable structural unit.

A disadvantage here is that the required interaction between the recess of the bearing outer ring and the holding bore of the bearing carrier demands very low tolerances. In other words, for the elastic deflection and the elastic spring-back of the retaining lugs to be possible at all, the bearing carrier and the bearing ring must be coordinated with one another very closely with regard to their tolerances, which entails an increased production expenditure. For example, it is necessary for the recess to be re-worked again after the heat treatment of the bearing outer ring, for example by means of hard grinding or hard turning. A further disadvantage arises from the fact that the connection between the bearing carrier and the bearing is very inflexible because a new bearing carrier must always be produced for any change in diameter of the bearing.

A further generic bearing arrangement is already known from DE 10 2005 012 323 B3. As can be gathered from the description and the associated figures, the bearing outer ring of a ball bearing is provided with a recess onto which a bearing carrier is placed with its holding bore. The cohesion between the bearing outer ring and the bearing carrier is realized in that the bearing carrier and bearing outer ring are connected in a positively locking fashion by means of a spring element which has a plurality of retaining lugs which are spaced apart uniformly around the circumference and which come into contact with an undercut of the recess.

The disadvantages highlighted above fundamentally apply here too. This means that said connecting arrangement is also very inflexible since a suitable spring element must be produced for each bearing arrangement. Said spring element is composed of a high-grade component and, on account of its complex shaping, is difficult to produce, which makes said bearing arrangement more expensive overall.

### SUMMARY OF THE INVENTION

Taking the disadvantages of the known prior art as a starting point, the invention is therefore based on the object of providing a generic bearing arrangement whose connection between the bearing and bearing carrier can be produced in a simple manner and which also has a high degree of flexibility.

According to the invention, said object is achieved according to the characterizing part of claim 1 in conjunction with its preamble in that the recess has, at its axially inner end, an undercut whose diameter in relation to a bearing axis is smaller than a diameter formed by an axially running part of the recess, with a slotted annular retaining element being inserted into the undercut, which retaining element overlaps the bearing carrier in a positively locking manner in the radial direction at at least one circumferential point.

The invention is therefore aimed at the use of a variable annular retaining element for the positively locking connection between the bearing and bearing carrier, the circumferential extent of which retaining element can be varied as a result of its radial slot. It is thereby possible firstly for the retaining element according to the invention to be mounted in a simple manner, for example by virtue of it being expanded and inserted into the undercut. Secondly, the circumferential extent of said retaining element designed according to the invention can be varied on account of its radial slot, such that it can be used for bearings and bearing carriers of different dimensions.

In a refinement of the invention as claimed in claim 2, the retaining element is of substantially L-shaped design, with an axially aligned ring body being arranged between the bearing carrier and the bearing outer ring, which ring body merges at one axial end into a radially inwardly directed flange and has retaining lugs at the other axial end at a plurality of spaced-apart circumferential points, which retaining lugs, after being folded over, overlap the bearing carrier in the radial direction.

The advantage of said annular retaining element is that it is easy to produce and that the positively locking connection is ensured by means of a simple folding-over of its retaining lugs. In this connection, according to a further feature as claimed in claim 3, it has proven to be advantageous for the ring body to be arranged between the bearing carrier and the outer ring with a clearance fit or interference fit.

According to a further feature as claimed in claim 4, it is provided that the retaining element is produced by means of a non-cutting shaping process. As is known to a person skilled in the art, it is thereby possible to cost-effectively produce retaining elements of said type in different dimension sizes and different shapes.

It has also proven to be advantageous, according to another additional feature as claimed in claim 5, for the retaining element to have a transport securing facility in the form of a predetermined breaking point. Said predetermined breaking point initially prevents the retaining element from having its radial slot which makes its varied circumferential extent possible. The lack of said radial slot facilitates in particular the assembly or supply to the assembled unit, since the retaining elements cannot become hooked into one another by means of their radial slots.

Finally, claims 6 and 7 describe two associated methods for producing a bearing arrangement according to the invention. Accordingly, it is provided in claim 6 that the retaining element is produced as a profiled endless strip by means of a non-cutting shaping process, a suitable strip end is subsequently cut to length, and said strip end is subsequently bent to form a retaining element. Claim 7 discloses the other variant, according to which the retaining element is produced as an individual part with a transport securing facility in the form of a predetermined breaking point. In both cases, the slotted annular retaining element is expanded and allowed to contract into the undercut of the bearing outer ring, before the bearing carrier is pushed onto the retaining element and subsequently the retaining lugs are bent over.

Further features of the invention will emerge from the following description and from the drawings which illustrate an exemplary embodiment of the invention in simplified form.

### BRIEF DESCRIPTION OF THE DRAWINGS

In the drawings:

FIG. 1 shows a perspective illustration of a bearing arrangement according to the invention;

FIG. 2 shows a side view of said bearing arrangement;

FIG. 3 shows an axial section along the line III-III in FIG. 2;

FIG. 4 shows an enlarged illustration of a detail from FIG. 3;

FIG. 5 shows a side view of a retaining element according to the invention;

FIG. 6 shows a perspective illustration of the retaining element according to the invention;

FIG. 7 shows an enlarged illustration of a detail from FIG. 5; and

FIG. 8 shows a further enlarged illustration of a detail from FIG. 5.

### DETAILED DESCRIPTION OF THE DRAWINGS

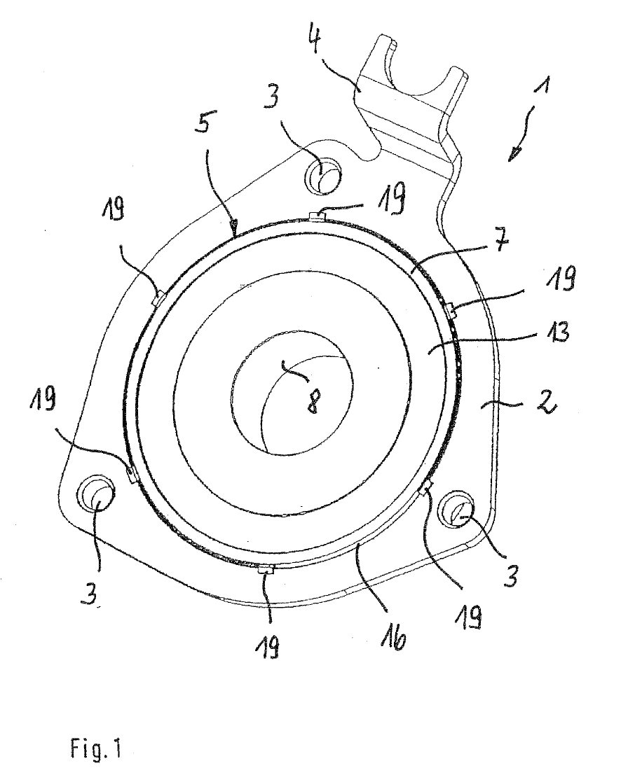

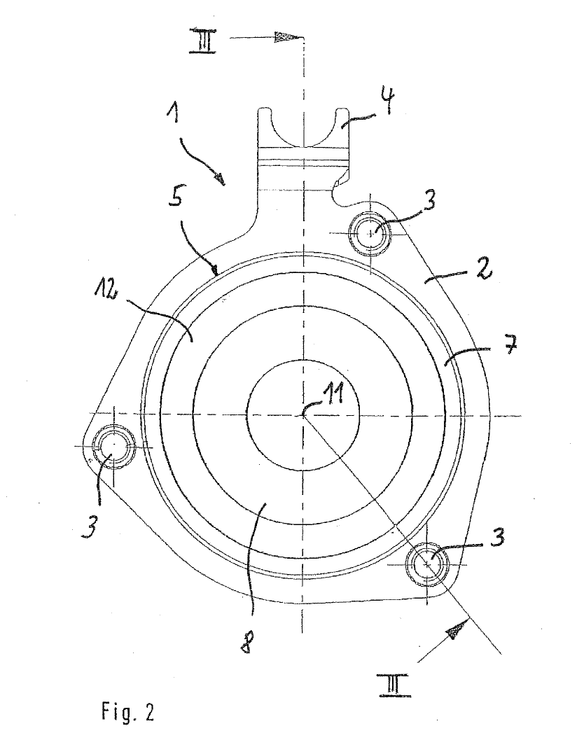

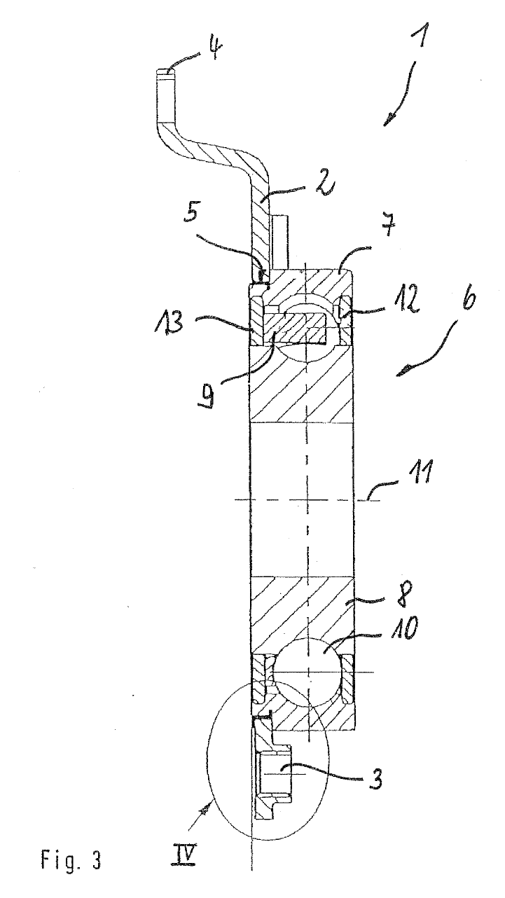

As can be seen in particular from FIGS. 1, 2 and 3, the bearing arrangement 1 according to the invention is composed of the bearing carrier 2 which is of substantially planar design and which is provided with three fastening bores 3 in said region. At its upper end, the bearing carrier 2 merges into the angled part 4, wherein the geometric contour of the bearing carrier 2 is however very much of secondary significance for the invention. The bearing carrier 2 holds, in its holding bore 5, a bearing 6 which is composed of the bearing outer ring 7 and the bearing inner ring 8. Between the two bearing rings 7, 8, bearing balls 10, which are guided in a cage 9, roll about their axis 11 on raceways (not shown in any more detail). Furthermore, the bearing 6 is sealed off at both sides by cover disks 12, 13. These firstly prevent dirt from penetrating into the bearing 6 from the outside and secondly prevent lubricant from escaping out of the bearing 6 from the inside. As can be seen in particular from the enlarged illustration in FIG. 4, the bearing outer ring 7 is provided with an encircling stepped recess 14 which merges at its axially inner end into an undercut 15. In relation to the bearing axis 11, the base of the undercut 15 is assigned the diameter D1 and the lateral surface of the recess 14 which runs in the axial direction is assigned the diameter D2, where D1<D2.

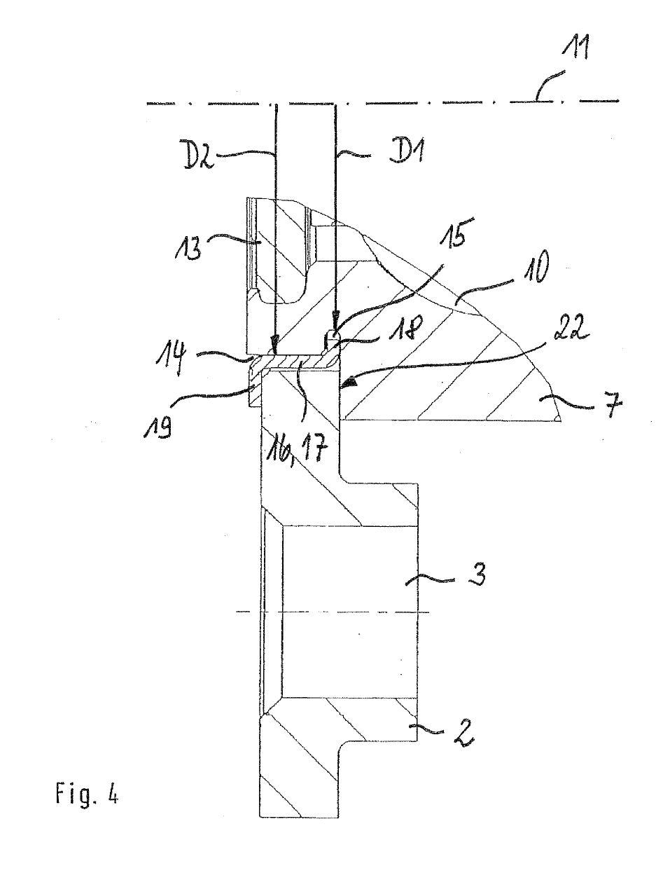

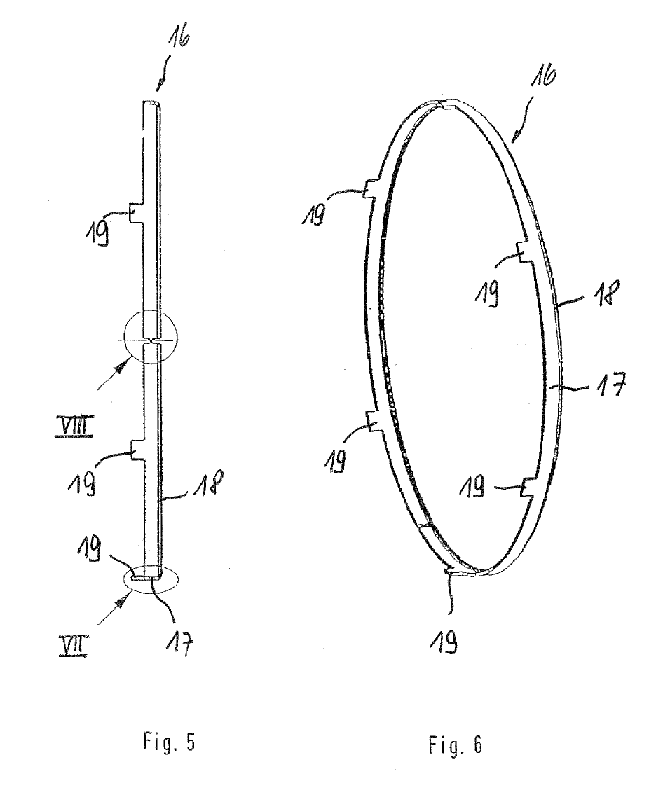

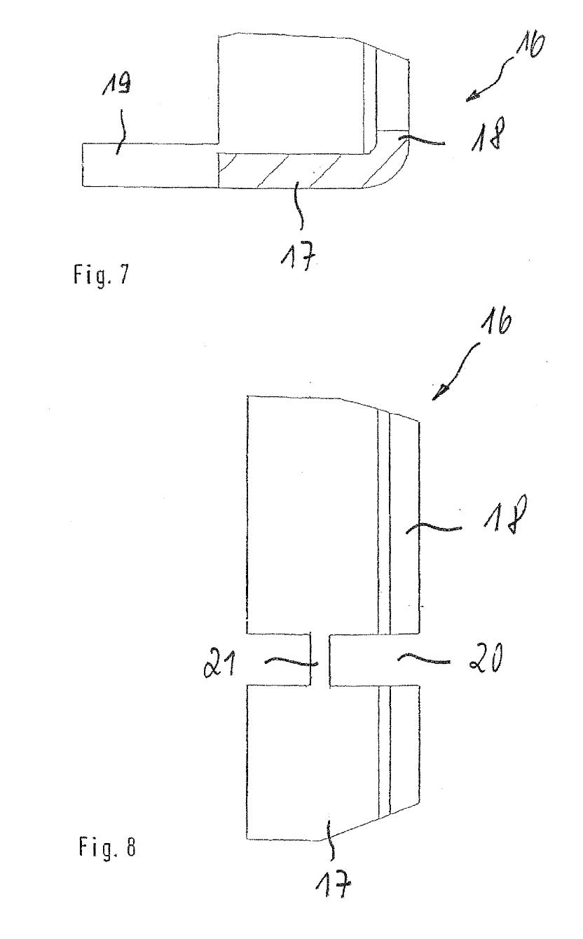

As shown in FIGS. 5, 6, 7 and 8, the retaining element 16 according to the invention is composed of the ring body 17 which runs in the axial direction and which merges at one end into the radially inwardly aligned flange 18. At the opposite axial end, the annular body 17 is provided with a plurality of retaining lugs 19 spaced apart uniformly around the circumference, which retaining lugs 19 initially still run in the axial direction. As can be seen in particular from FIG. 8, the retaining element 16 is provided with a slot 20, but in said illustration, the slot 20 is initially bridged by the predetermined breaking point 21. Said predetermined breaking point 21 is severed before the retaining element is assembled into the bearing arrangement 1, for example by virtue of the two ends of the retaining element 16 being moved together or apart. In this way, a slotted retaining element 16 is produced which can be both reduced in size and increased in size in terms of its circumferential extent.

The assembly of the bearing arrangement 1 according to the invention is explained in more detail below with reference to the enlarged illustration of FIG. 4.

Firstly, the annular retaining element 16 which is provided with the continuous slot 20 is expanded such that it is snapped with its radially inwardly aligned flange 18 into the undercut 15 of the bearing outer ring 7. Here, the retaining element 16 is designed such that its ring body 17 comes completely into contact against the lateral surface of the recess 14. In said state of assembly, in contrast to the illustration of FIG. 4, the retaining lugs 19 are still aligned axially, that is to say have not yet been folded over. Said axial alignment of the retaining lugs 19 can be seen from FIGS. 5, 6 and 7. After the retaining element has been snapped into the undercut 15, the bearing carrier 2 is pushed onto the retaining element 16 in the axial direction from left to right until said bearing carrier 2 comes into contact against the radially running contact surface 22 of the recess 14. Once this has happened, the retaining lugs 19 are moved from their axial alignment into a radial alignment by means of a suitable tool, such that said retaining lugs 19 bear against the end side (not shown) of the bearing carrier 2. In this way, a positively locking connection is produced between the bearing 6 and the bearing carrier 2, with it being possible, as already described above, for the retaining element 16 to be accommodated between the bearing 6 and the bearing carrier 2 either with a clearance fit or else with an interference fit.

### REFERENCE SYMBOLS

1 Bearing arrangement

2 Bearing carrier

3 Fastening bore

4 Angled part

5 Holding bore

6 Bearing

7 Bearing outer ring

8 Bearing inner ring

9 Cage

10 Bearing ball

11 Bearing axis

12 Cover disk

13 Cover disk

14 Recess

15 Undercut

16 Retaining element

17 Ring body

18 Flange

19 Retaining lug

20 Slot

21 Predetermined breaking point

22 Contact surface

D1 Diameter

D2 Diameter

1. A bearing arrangement, comprising:
a bearing carrier, which is of at least partially planar design, having a holding bore; and
at least one bearing, which is connected to the bearing carrier, having an outer ring with a recess for holding the bearing carrier,
wherein the recess has, at an axially inner end, an undercut with a diameter in relation to a bearing axis which is smaller than a diameter formed by an axially running part of the recess, with a slotted annular retaining element being inserted into the undercut, which overlaps the bearing carrier in a positively locking manner in a radial direction at least one circumferential point.

2. The bearing arrangement of claim 1, wherein the retaining element is of substantially L-shaped design, with an axially aligned ring body being arranged between the bearing carrier and the bearing outer ring, which merges at one axial end into a radially inwardly aligned flange and has retaining lugs at the other axial end at a plurality of spaced-apart circumferential points, which, after being folded over, overlap the bearing carrier in a radial direction.

3. The bearing arrangement of claim 2, wherein the ring body is arranged between the bearing carrier and the bearing outer ring with a clearance fit or interference fit.

4. The bearing arrangement of claim 1, wherein the retaining element is produced by means of a non-cutting shaping process.

5. The bearing arrangement of claim 1, wherein the retaining element has a transport securing facility in the form of a predetermined breaking point.

6. A method for producing a bearing arrangement of claim 1, comprising the steps of:
producing the retaining element as a profiled endless strip by means of a non-cutting shaping process;
cutting a strip end to length so as to have a longitudinal extent matching a predefined circumferential extent of the bearing and the bearing carrier;
bending the strip end round so as to form the retaining element;
expanding the retaining element to allow the retaining element to contract into the undercut of the bearing outer ring;
pushing the bearing carrier onto the retaining element; and
bending over retaining lugs of the retaining element.

7. A method for producing a bearing arrangement of claim 1, comprising the steps of:
producing the retaining element as an individual part with a transport securing facility in the form of a predetermined breaking point;
severing the predetermined breaking point;
expanding the retaining element to allow the retaining element to contract into the undercut of the outer ring;
pushing the bearing carrier onto the retaining element; and
bending over retaining lugs of the retaining element.
